(19) United States
(12) Patent Application Publication
(10) Pub. No.: US 2016/0327836 A1
(43) Pub. Date: Nov. 10, 2016

(54) OPTICAL DEVICE AND DISPLAY DEVICE PROVIDED WITH SAME

(71) Applicant: SHARP KABUSHIKI KAISHA, Osaka-shi (JP)

(72) Inventors: Hiroyuki MORIWAKI, Osaka-shi (JP); Masumi KUBO, Osaka-shi (JP); Kazutaka HANAOKA, Osaka-shi (JP)

(21) Appl. No.: 15/108,140

(22) PCT Filed: Aug. 29, 2014
(86) PCT No.: PCT/JP2014/072758

§ 371 Date: Jun. 24, 2016

(30) Foreign Application Priority Data
Dec. 27, 2013 (JP) 2013-271537

(51) Int. Cl. G02F 1/1343; G02F 1/1337; G02F 1/137; G02F 1/17

(52) U.S. Cl. CPC G02F 1/134309; G02F 1/13439; G02F 1/172; G02F 1/1337; G02F 1/137; G02F 2001/133742; G02F 2001/13706

(57) ABSTRACT

An optical device (100) includes: a first substrate (10) and a second substrate (20) opposing each other; an optical layer (30) interposed between the first substrate and the second substrate; and a first electrode (11) and a second electrode (12) to which different potentials can be applied. The optical layer includes a medium (31) and anisotropically-shaped particles (32) dispersed in the medium, the anisotropically-shaped particles having shape anisotropy. The alignment direction of the anisotropically-shaped particles changes depending on a voltage applied across the optical layer. The voltage applied across the optical layer is an oscillating voltage alternately including a first period in which an absolute value is relatively large and a second period in which an absolute value is relatively small.

### TECHNICAL FIELD

The present invention relates to an optical device, and more particularly to an optical device including an optical layer which contains anisotropically-shaped particles. Moreover, the present invention also relates to a display device including such an optical device.

### BACKGROUND ART

An optical device which controls the transmittance (or reflectance) of incident light needs a high contrast ratio and a high efficiency of light utilization.

One well-known optical device for controlling transmittance of light with voltage application is the liquid crystal panel. A liquid crystal panel includes a pair of substrates and a liquid crystal layer which is provided between these substrates. In a liquid crystal panel, liquid crystal molecules within the liquid crystal layer undergo changes in their alignment depending on the level of voltage being applied across the liquid crystal layer, which results in changes in the transmittance of light entering the liquid crystal panel. Liquid crystal panels have a very high contrast ratio, and therefore are widely used in display devices.

However, many liquid crystal panels are of the type that employs polarizers; therefore, half or more of the light which is utilized for displaying is absorbed at the polarizers. This results in a low efficiency of light utilization. Accordingly, development of optical devices which do not require polarizers has been under way in the recent years.

The present applicant proposes, in Patent Documents 1 and 2, display panels including a light modulating layer which contains anisotropically-shaped members. In the display panels of Patent Documents 1 and 2, the anisotropically-shaped members dispersed in a medium are rotated (i.e., the alignment direction is changed) by application of an electric field across the light modulating layer, whereby the light transmittance (or light reflectance) of the light modulating layer is changed.

The display panels of Patent Documents 1 and 2 mentioned above do not require polarizers, and therefore can attain a higher efficiency of light utilization than that of a liquid crystal panel.

### CITATION LIST

### Patent Literature

Patent Document 1: WO 2013/129373

Patent Document 2: WO 2013/172374

### SUMMARY OF INVENTION

### Technical Problem

However, the present inventors conducted detailed research and found that a display panel including a light modulating layer which contains anisotropically-shaped members has the following disadvantages.

The alignment direction of the anisotropically-shaped members cannot be changed without sufficient electric field intensity. If there is a region of small electric field intensity in a panel, the alignment direction of the anisotropically-shaped members that are present in that region cannot be sufficiently changed. Therefore, the degree of change in optical characteristics (light transmittance and light reflectance) is small in that region. If coagulation of the anisotropically-shaped members occurs, the coagulated anisotropically-shaped members, i.e., the entire coagulated mass, loses the shape anisotropy so that it becomes near-spherical, while their alignment direction cannot be sufficiently changed. Thus, also in this case, the degree of change in the optical characteristics is small.

The present invention has been made in view of the above problems, and an objective thereof is to provide an optical device including an optical layer which contains anisotropically-shaped particles, in which the proportion (probability of existence) of anisotropically-shaped particles whose alignment direction changes in response to application of a voltage is increased.

### Solution to Problem

An optical device according to an embodiment of the present invention includes: a first substrate and a second substrate opposing each other; an optical layer interposed between the first substrate and the second substrate; and a first electrode and a second electrode to which different potentials can be applied, wherein the optical layer includes a medium and anisotropically-shaped particles dispersed in the medium, the anisotropically-shaped particles having shape anisotropy, an alignment direction of the anisotropically-shaped particles changes depending on a voltage applied across the optical layer, and the voltage applied across the optical layer is an oscillating voltage alternately including a first period in which an absolute value is relatively large and a second period in which an absolute value is relatively small.

In one embodiment, an absolute value of the oscillating voltage in the second period is not more than 50% of an absolute value of the oscillating voltage in the first period.

In one embodiment, an absolute value of the oscillating voltage in the second period is not more than 2% of a peak-to-peak voltage value of the oscillating voltage.

In one embodiment, the oscillating voltage in the second period is about 0 V.

In one embodiment, the oscillating voltage in a certain first period and the oscillating voltage in another first period have opposite polarities.

In one embodiment, after the oscillating voltage is applied across the optical layer for a predetermined time period, the optical device which has the above-described configuration can apply across the optical layer an AC voltage alternately including a third period and a fourth period which have generally equal absolute values and which have opposite polarities.

In one embodiment, the predetermined time period is not less than 5 msec and not more than 5000 msec.

In one embodiment, the predetermined time period is not less than 5 msec and not more than 500 msec.

In one embodiment, the optical device which has the above-described configuration can apply a lateral field as the oscillating voltage across the optical layer.

In one embodiment, the first electrode and the second electrode are provided on the first substrate side.

In one embodiment, each of the first electrode and the second electrode is an interdigitated electrode having a plurality of branches, the first electrode and the second electrode are disposed so that the plurality of branches of the respective electrodes mesh with one another via a predetermined interspace, and the relationships of w₁<g and w₂<g are satisfied, where w₁ is a width of each of the plurality of branches of the first electrode, w₂ is a width of each of the plurality of branches of the second electrode, and g is the predetermined interspace.

In one embodiment, the first electrode, an insulator layer, and the second electrode are arranged in this order from the optical layer side, the first electrode has a plurality of branches or a plurality of slits, and the relationship of w_{B}<g_{B} or w_{S}>g_{S} is satisfied, where w_{B} is a width of each of the plurality of branches, g_{B} is a distance between adjoining two of the plurality of branches, w_{S} is a width of each of the plurality of slits, and g_{S} is a distance between adjoining two of the plurality of slits.

In one embodiment, the optical device can apply a longitudinal field as the oscillating voltage across the optical layer.

In one embodiment, the optical device which has the above-described configuration further includes a third electrode which is provided on the second substrate side and which opposes the first electrode and the second electrode.

In one embodiment, the optical device which has the above-described configuration is driven at a frequency of not less than 1 Hz and not more than 300 Hz.

In one embodiment, the optical device which has the above-described configuration is driven at a frequency of not less than 1 Hz and not more than 100 Hz.

In one embodiment, the medium is a liquid crystal material.

In one embodiment, when no voltage is applied across the optical layer, the anisotropically-shaped particles orient generally perpendicular to a substrate plane.

A display device according to an embodiment of the present invention includes an optical device which has the above-described configuration.

### Advantageous Effects of Invention

According to an embodiment of the present invention, in an optical device including an optical layer which contains anisotropically-shaped particles, the proportion (probability of existence) of anisotropically-shaped particles whose alignment direction changes in response to application of a voltage can be increased.

### BRIEF DESCRIPTION OF DRAWINGS

FIG. 1 A cross-sectional view schematically showing a display device 110 according to an embodiment of the present invention, showing a cross section taken along line 1A-1A′ of FIG. 2.

FIG. 2 A plan view schematically showing a first electrode 11 and a second electrode 12 of the display device 110.

FIG. 3 (a) is a diagram schematically showing the display device 110 in the absence of an electric field applied across an optical layer 30; and (b) is a diagram schematically showing the display device 110 in the presence of a lateral field applied across the optical layer 30.

FIG. 4 A diagram schematically showing the display device 110 in the presence of a longitudinal field applied across the optical layer 30.

FIG. 5 (a) is a diagram showing how the optical layer 30 may appear immediately after the electric field applied across the optical layer 30 is changed from a lateral field to a longitudinal field; and (b) is a diagram showing how the optical layer 30 may appear after the lapse of a sufficient time therefrom.

FIG. 6 A diagram showing the result of a simulation of the alignment of liquid crystal molecules in the presence of a lateral field applied across the optical layer 30.

FIG. 7 A diagram showing the waveform of an AC voltage applied across an optical layer 30 of a display device 610 of a comparative example, showing a voltage waveform in the case where the display device 610 performs displaying at the same grayscale level over a plurality of frames.

FIG. 8 (a) to (d) are diagrams showing alignment states of anisotropically-shaped particles 32 which may appear when an AC voltage which has the waveform shown in FIG. 7 is applied as the lateral field across the optical layer 30 of the display device 610 of the comparative example, respectively showing the alignment states in the initial state (i.e., in the absence of an applied voltage) and in the first, second and third frames.

FIG. 9 A diagram showing the waveform of an oscillating voltage applied across the optical layer 30 of the display device 110 according to an embodiment of the present invention, showing a voltage waveform in the case where the display device 110 performs displaying at the same grayscale level over a plurality of frames.

FIG. 10 (a) to (d) are diagrams showing alignment states of anisotropically-shaped particles 32 which may appear when an oscillating voltage which has the waveform shown in FIG. 9 is applied as the lateral field across the optical layer 30 of the display device 110 according to an embodiment of the present invention, respectively showing the alignment states in the initial state (i.e., in the absence of an applied voltage) and in the first, second and third frames.

FIG. 11 A diagram showing another example of the waveform of the oscillating voltage applied across the optical layer 30 of the display device 110 according to an embodiment of the present invention.

FIGS. 12 (a) and (b) are diagrams showing other examples of the waveform of the oscillating voltage applied across the optical layer 30 of the display device 110 according to an embodiment of the present invention.

FIG. 13 (a) is a plan view showing an alignment state of the anisotropically-shaped particles 32 which may appear immediately after a lateral field is applied as the oscillating voltage across the optical layer 30; and (b) is a plan view showing an alignment state of the anisotropically-shaped particles 32 which may appear during a period where a large voltage is applied again across the optical layer 30 after passage of a period of small applied voltage.

FIG. 14 A cross-sectional view schematically showing another construction of the display device 110 according to an embodiment of the present invention, showing a cross section taken along line 14A-14A′ of FIG. 15.

FIG. 15 A plan view schematically showing another construction of the first electrode 11 and the second electrode 12 of the display device 110.

FIGS. 16 (a) and (b) are diagrams for illustrating the effects achieved by application of a longitudinal field across the optical layer 30.

FIG. 17 A cross-sectional view schematically showing another construction example of the display device 110 according to an embodiment of the present invention.

FIG. 18 (a) is an optical microscopic image of the optical layer 30 in the absence of an applied voltage; (b) to (d) are diagrams showing the waveforms of voltages applied across the optical layer 30; and (e) to (g) are optical microscopic images of the optical layer 30 in the presence of applied voltages which have the waveforms shown in (b) to (d), respectively.

FIGS. 19 (a) to (h) are diagrams for illustrating the results of verification conducted as to the relationship between the peak-to-peak voltage value of the oscillating voltage and the display brightness.

FIG. 20 A diagram showing the relationship between various voltage waveforms and the reflectance.

FIG. 21 A diagram showing an example of the waveform of a voltage applied across the optical layer 30 of the display device 110 according to an embodiment of the present invention.

FIG. 22 A diagram showing the interconnection between electrodes, TFTs, and wires in the case where active matrix driving is performed in the display device 110 according to an embodiment of the present invention.

FIG. 23 A diagram showing the interconnection between electrodes, TFTs, and wires in the case where active matrix driving is performed in the display device 110 according to an embodiment of the present invention.

FIG. 24 A diagram showing an example of the voltage waveforms of a gate signal, a source signal and a common voltage in the construction shown in FIG. 22.

### DESCRIPTION OF EMBODIMENTS

Hereinafter, embodiments of the present invention will be described with reference to the drawings. Note that the present invention is not limited to the following embodiments.

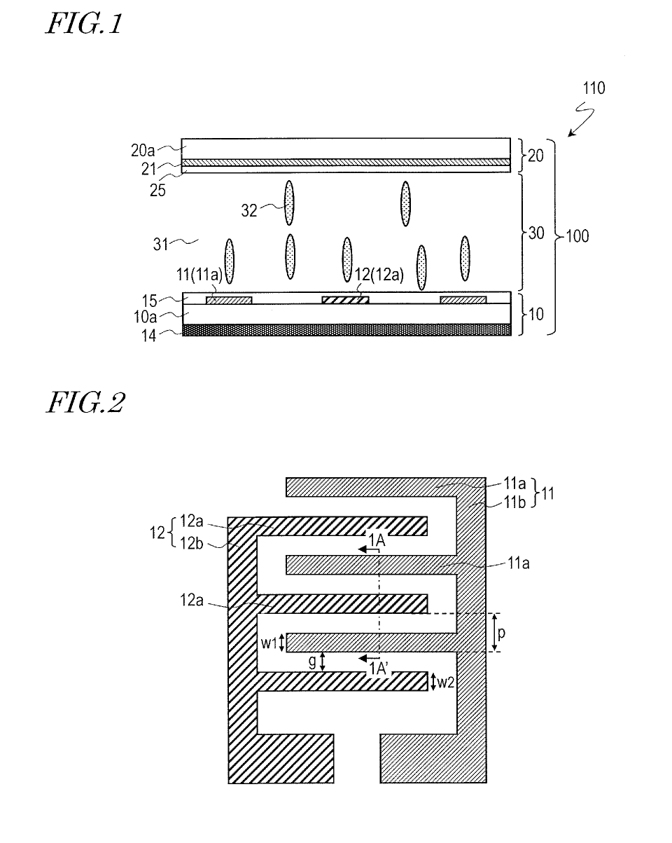

FIG. 1 shows a display device 110 according to the present embodiment. FIG. 1 is a cross-sectional view schematically showing the display device 110 (showing a cross section taken along line 1A-1A′ of FIG. 2 which will be described later).

The display device 110 is a reflection type display device that can perform displaying in a reflection mode by utilizing light which is incident from the exterior (ambient light). As shown in FIG. 1, the display device 110 includes a display panel (optical device) 100, and has a plurality of pixels in a matrix array.

The display panel 100 includes a first substrate 10 and a second substrate 20 opposing each other, an optical layer (display medium layer) 30 which is provided between the first substrate 10 and the second substrate 20, and first electrodes 11 and second electrodes 12 to which respectively different potentials may be supplied. The display panel 100 further includes a third electrode 13 opposing the first electrodes 11 and the second electrodes 12. Between the first substrate 10 and the second substrate 20, the first substrate 10 that is relatively located on the rear face side may hereinafter be referred to as the “rear substrate”, whereas the second substrate 20 that is relatively located on the front face side (i.e., the viewer's side) may hereinafter be referred to as the “front substrate”.

The first substrate (rear substrate) 10 includes the above-described first electrodes 11 and second electrodes 12. That is, the first electrodes 11 and the second electrodes 12 are provided on the first substrate 10 side. A first electrode 11 and a second electrode 12 are provided for each of the plurality of pixels. Having a plurality of branches 11a and 12a, each first electrode 11 and each second electrode 12 constitute interdigitated electrodes. FIG. 2 shows a planar structure of a first electrode 11 and a second electrode 12.

As shown in FIG. 2, each first electrode 11 includes a stem 11b and a plurality of branches 11a extending from the stem 11b. Similarly, each second electrode 12 includes a stem 12b and a plurality of branches 12a extending from the stem 12b. The first electrode 11 and the second electrode 12 are disposed so that their respective branches 11a and 12a mesh with one another via a predetermined interspace (which hereinafter may be referred to as the “interelectrode distance”) g.

There is no particular limitation as to the interelectrode distance g. There is also no particular limitation as to the width w₁ of each branch 11a of the first electrode 11 and the width w₂ of each branch 12a of the second electrode 12. The interelectrode distance g, the width w₁ of each branch 11a of the first electrode 11, and the width w₂ of each branch 12a of the second electrode 12 are each in the range of, for example, several micrometers to ten and a few micrometers. The width w₁ of each branch 11a of the first electrode 11 and the width w₂ of each branch 12a of the second electrode 12 may be equal or different. Note that, however, as will be described later, it is preferred that the width w₁ of each branch 11a of the first electrode 11, the width w₂ of each branch 12a of the second electrode 12, and the interelectrode distance g satisfy the relationships of w₁<g and w₂<g.

Moreover, the first substrate 10 is typically an active matrix substrate, including a thin film transistor (TFT) provided for each pixel and various wiring lines (e.g., gate lines and source lines electrically connected to the TFTs) (neither of them is shown here). The first electrode 11 and the second electrode 12 are each electrically connected a corresponding TFT so as to receive a voltage corresponding to a source signal via the TFT.

The first substrate 10 further includes an optical absorption layer 14 that absorbs light. There is no particular limitation as to the material of the optical absorption layer 14. As the material of the optical absorption layer 14, pigments can be used, for example, which are used as the material of a black matrix, etc., that is included in the color filters of a liquid crystal display device or the like. Alternatively, as the optical absorption layer 14, a low-reflection chromium film of double-layer structure (i.e., having a structure in which a chromium layer and a chromium oxide layer are stacked) can also be used.

The component elements of the first substrate 10 (i.e., the aforementioned first electrodes 11, second electrodes 12, optical absorption layer 14, and so on) are supported by a substrate 10a which is electrically insulative (e.g., a glass substrate). Although FIGS. 1(a) and (b) illustrate the optical absorption layer 14 as being provided at the rear face side of the substrate 10a, the optical absorption layer 14 may alternatively be provided on the optical layer 30 side of the substrate 10a.

The second substrate (front substrate) 20 includes the above-described third electrode 21. That is, the third electrode 21 is provided on the second substrate 20 side. The third electrode(s) 21 may be a so-called spread electrode that does not have any slits or bevels formed therein. It is not necessary that an electrically independent third electrode 21 be provided for each pixel, but a single continuous electrically conductive film may commonly be provided for all of the pixels (i.e., a common electrode). In the case where the third electrode 21 is a spread electrode that is common to all pixels, patterning by a photolithography technique is not needed, so that the production cost can be reduced. In the case of conducting multicolor displaying, the second substrate 20 further includes color filters (not shown). Further, an overcoat layer (dielectric layer) may be provided on the third electrode 21. Providing the overcoat layer enables to relax a longitudinal field which is inevitably applied during application of a lateral field. Therefore, a more intense lateral field can be applied across the optical layer 30.

The component elements of the second substrate 20 (the aforementioned third electrode(s) 21 and the like) are supported on an electrically insulative substrate (e.g., glass substrate) 20a.

The first electrodes 11, the second electrodes 12, and the third electrode(s) 21 are each made of a transparent electrically conductive material such as ITO (indium tin oxide) or IZO (indium zinc oxide). There is no particular limitation as to the method of depositing the electrically conductive films to become these electrodes; various known methods, such as a sputtering technique, a vacuum vapor deposition technique, and a plasma CVD technique, can be used. Also, there is no particular limitation as to the method of patterning electrically conductive films to form the first electrodes 11 and the second electrodes 12 which are interdigitated electrodes; known patterning methods such as photolithography can be used. The thicknesses of the first electrodes 11, the second electrodes 12, and the third electrode(s) 21 are e.g. 100 nm.

The optical layer (display medium layer) 30 includes: a medium 31 in liquid form; and particles having shape anisotropy (hereinafter referred to as “anisotropically-shaped particles”) 32, which are dispersed in the medium 31. The aforementioned first substrate 10 and second substrate 20 are attached together via a sealing portion (not shown here) which is formed around the displaying region, such that the medium 31 and the anisotropically-shaped particles 32 are contained within a region that is surrounded by the sealing portion (i.e., the displaying region). There is no particular limitation as to the thickness (cell gap) of the optical layer 30. The optical layer 30 may have a thickness of e.g. 5 μm to 30 μm.

The anisotropically-shaped particles 32 are light reflective. The anisotropically-shaped particles 32 are in flake form (thin-strip shaped), for example.

The alignment direction of the anisotropically-shaped particles 32 changes depending on the applied voltage (i.e., applied electric field) across the optical layer 30. Since the anisotropically-shaped particles 32 have shape anisotropy, if the alignment direction of the anisotropically-shaped particles 32 changes, the projected area of each anisotropically-shaped particle 32 onto the substrate plane (the substrate plane of the first substrate 10) also changes, whereby the optical characteristics (i.e., reflectance herein) of the optical layer 30 changes accordingly. The display device 110 of the present embodiment takes advantage of this to perform displaying. The reason why the alignment direction of the anisotropically-shaped particles 32 changes depending on the applied voltage will be described later in detail.

In the display device 110 of the present embodiment, the medium 31 is a liquid crystal material, containing liquid crystal molecules. Herein, the liquid crystal material has positive dielectric anisotropy. That is, the medium 31 is a liquid crystal material of a so-called positive type, such that the dielectric constant ∈_{//} of the liquid crystal molecules along the major axis direction is greater than the dielectric constant ∈_{⊥} along the minor axis direction.

The first substrate 10 and the second substrate 20 include, respectively, vertical alignment films 15 and 25 provided at the optical layer 30 side. As will be described in detail later, the vertical alignment films 15 and 25 possess an alignment regulating force for aligning the anisotropically-shaped particles 32 substantially vertically with respect to the substrate plane (the substrate plane of the first substrate 10 or the second substrate 20). Moreover, herein, the vertical alignment films 15 and 25 also possess an alignment regulating force for aligning the liquid crystal molecules contained in the medium (liquid crystal material) 31 substantially vertically with respect to substrate plane (the substrate plane of the first substrate or the second substrate 20). Note that it is not necessary for both of the first substrate 10 and the second substrate 20 to have vertical alignment films provided thereon; only one of them (e.g., only the first substrate 10) may have a vertical alignment film provided thereon.

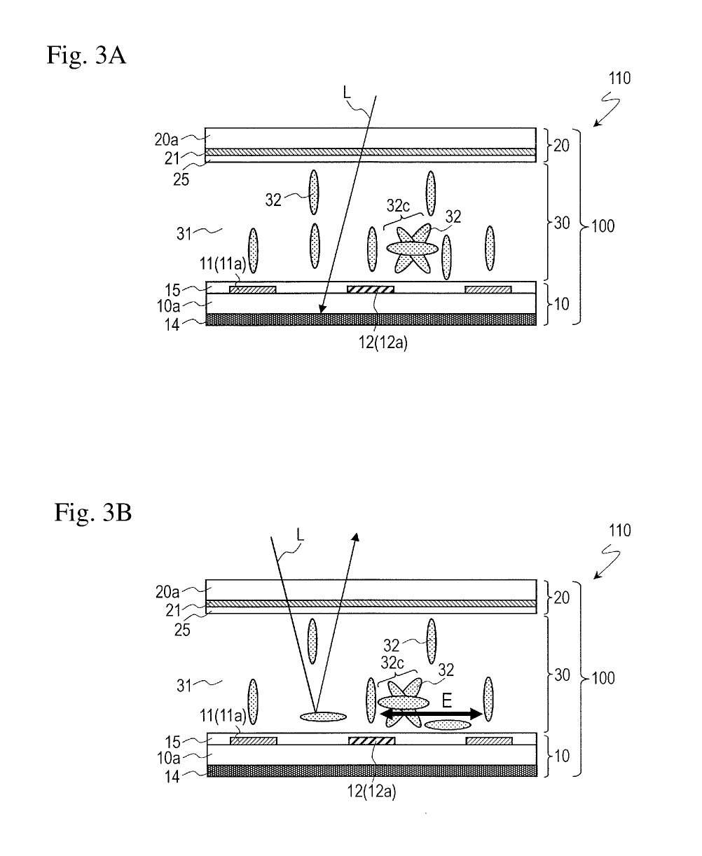

Hereinafter, the reason why the alignment direction of the anisotropically-shaped particles 32 changes depending on the applied voltage (applied electric field) is described more specifically with reference to FIGS. 3(a) and 3(b). FIG. 3(a) is a diagram schematically showing the display device 110 in the absence of an electric field applied across the optical layer 30. FIG. 3(b) is a diagram schematically showing the display device 110 in the presence of a lateral field applied across the optical layer 30.

When no electric field is applied to the optical layer 30, the anisotropically-shaped particles 32 are aligned so that they are (i.e., their longitudinal directions are) substantially perpendicular to the substrate plane of the first substrate 10 (i.e., taking a vertical alignment state) as shown in FIG. 3(a) due to the alignment regulating forces of the vertical alignment films 15 and 25. Moreover, the liquid crystal molecules becoming aligned substantially vertically with respect to the substrate plane, due to the alignment regulating forces of the vertical alignment films 15 and 25, acts to assist in the anisotropically-shaped particles 32 taking a vertical alignment state. In this state, large part of incident ambient light L passes through the optical layer 30. That is, the optical layer 30 is in a transparent state. The ambient light which has passed through the optical layer 30 is absorbed by the optical absorption layer 14 and, therefore, this state achieves black displaying. In the present specification, that “the anisotropically-shaped particles 32 are aligned substantially vertically with respect to the substrate plane” refers to a state where the anisotropically-shaped particles 32 are aligned at angles exhibiting substantially similar optical characteristics to those in a state where they are aligned strictly vertically with respect to the substrate plane: specifically, a state where the anisotropically-shaped particles 32 are aligned at angles of 75° or more with respect to the substrate plane.

When a predetermined voltage is applied between the first electrode 11 and the second electrode 12, a lateral field is generated in the optical layer 30 as shown in FIG. 3(b). In FIG. 3(b), the direction of the electric field is indicated with arrow E. As can be seen from FIG. 3(b), the direction E of the electric field is substantially parallel to the substrate plane of the first substrate 10 (i.e., substantially perpendicular to the thickness direction of the optical layer 30).

At this time, as shown in FIG. 3(b), the anisotropically-shaped particles 32 are aligned so that they are (i.e., their longitudinal directions are) substantially parallel to the substrate plane of the first substrate 10 (i.e., taking a horizontal alignment state). The liquid crystal molecules also are aligned substantially in parallel to the substrate plane of the first substrate 10. In this state, a large part of the incident ambient light L is reflected by the anisotropically-shaped particles 32 in the optical layer 30. That is, the optical layer 30 takes a reflecting state; this state achieves white displaying. Moreover, gray scale displaying also becomes possible by applying a lower voltage than that applied for white displaying.

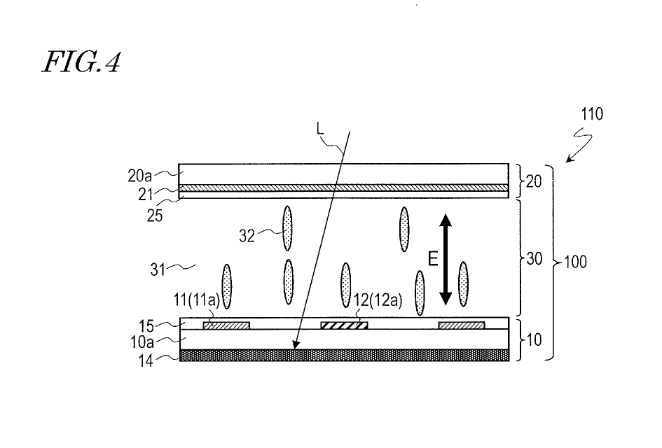

Since the display device 110 of the present embodiment includes the third electrode 21 which is arranged so as to oppose the first electrode 11 and the second electrode 12, it is also possible to apply a longitudinal field across the optical layer 30 as shown in FIG. 4. When a predetermined voltage is applied between the first electrode 11 and second electrode 12 and the third electrode 21, a longitudinal field is generated in the optical layer 30. Also in FIG. 4, the direction of the electric field is indicated with arrow E. As can be seen from FIG. 4, the direction E of the electric field is substantially perpendicular to the substrate plane of the first substrate (i.e., substantially parallel to the thickness direction of the optical layer 30).

In this case, the anisotropically-shaped particles 32 are aligned so that they are (i.e., their longitudinal directions are) substantially perpendicular to the substrate plane of the first substrate 10 (i.e., taking a vertical alignment state), as shown in FIG. 4. The liquid crystal molecules also are aligned substantially vertically with respect to the substrate plane of the first substrate 10. In this state, a large part of the incident ambient light L is transmitted through the optical layer 30. That is, the optical layer 30 takes a transparent state. Since the ambient light which is transmitted through the optical layer 30 is absorbed by the optical absorption layer 14, this state achieves black displaying.

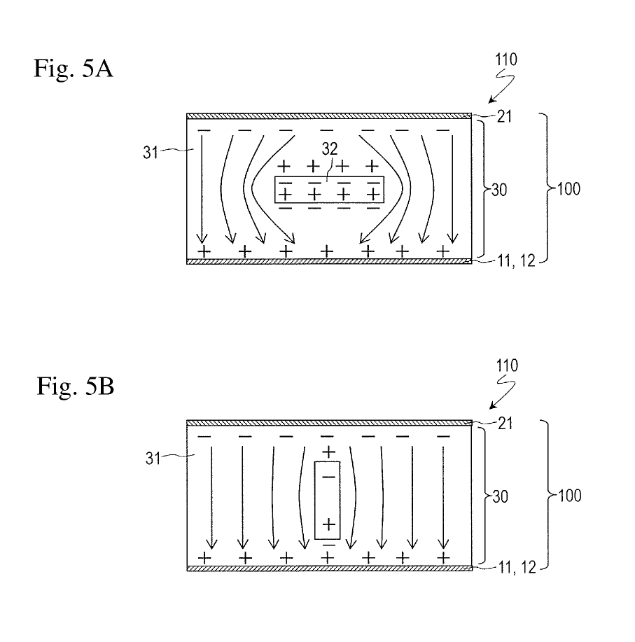

Such changes in the alignment of the anisotropically-shaped particles 32 are ascribable to a dielectrophoretic force due to interaction between an electric field and an electric dipole moment induced thereby. Hereinafter, with reference to FIGS. 5(a) and 5(b), this will be described more specifically. FIGS. 5(a) and 5(b) are diagrams showing how the optical layer 30 may appear (in terms of electric charge distribution and electric lines of force) immediately after the electric field being applied to the optical layer 30 is changed from a lateral field to a longitudinal field, and after the lapse of a sufficient time therefrom.

In the case where the dielectric constant of anisotropically-shaped particles 32 is unequal to the dielectric constant of the medium 31, if the direction of an applied field to the optical layer 30 changes, a large distortion occurs in the electric lines of force, as shown in FIG. 5(a). Therefore, as shown in FIG. 5(b), the anisotropically-shaped particles 32 rotate so as to result in the smallest energy.

Generally speaking, a dielectrophoretic force F_{dep} acting on particles which are dispersed in a medium is expressed by eq. (1) below, where ∈ₚ is the dielectric constant of the particles, ∈ₘ is the dielectric constant of the medium, a is the radius of the particles, and E is the intensity of the electric field. Note that Re in eq. (1) is an operator for extracting the real part. In the present embodiment, the medium 31P is a liquid crystal material, having dielectric anisotropy. That is, the dielectric constant ∈_{//} along the major axis direction of the liquid crystal molecules 31a is unequal to the dielectric constant ∈_{⊥} along their minor axis direction, presumably ∈ₘ=∈_{//}−∈_{⊥}=Δ∈.

$$\begin{matrix}[ math . 1 ] & \\ {F}_{dep} = 2 {πɛ}_{m} \cdot {a}^{3} \cdot Re \cdot ( \frac{{ɛ}_{p} - {ɛ}_{m}}{{ɛ}_{p} + 2 {ɛ}_{m}} ) \cdot ∇ {\vert E \vert}^{2} & ( 1 )\end{matrix}$$

As seen from the foregoing description, in addition to the above-described dielectrophoretic force, the alignment regulating force of the vertical alignment films 15 and 25 and the liquid crystal molecules support the anisotropically-shaped particles 32 in expressing a vertical alignment state, so that switching of the anisotropically-shaped particles 32 between a vertical alignment operation and a horizontal alignment operation can be suitably realized.

As described above, in the display device 110 of the present embodiment, the alignment direction of the anisotropically-shaped particles 32 can be changed by application of a voltage across the optical layer 30, and this can be utilized in performing displaying. Since the display device 110 does not require polarizers, high light utilization efficiency can be realized.

Note that, however, simply applying a voltage across the optical layer 30 cannot sufficiently change the alignment direction of anisotropically-shaped particles 32 in a region of small electric field intensity, and in that region, the degree of change in an optical characteristic (here, light reflectance) is small. The region of small electric field intensity corresponds to, for example, a region of the structure illustrated in FIG. 1 extending over the widthwise center of the branches 11a and 12a of the first electrode 11 and the second electrode 12 or a region of the structure near the second substrate 20 (i.e., a region which is distant from the first electrode 11 and the second electrode 12 that produce a lateral field). FIG. 3(b) shows that the alignment direction of the anisotropically-shaped particles 32 remains unchanged in these regions. FIGS. 3(a) and 3(b) also show coagulated anisotropically-shaped particles 32 (the entire coagulated mass is designated by reference numeral “32c”). Such coagulated anisotropically-shaped particles 32 cannot sufficiently change their alignment direction. Further, the coagulated anisotropically-shaped particles 32, i.e., the entire coagulated mass 32c, becomes near-spherical and has no shape anisotropy.

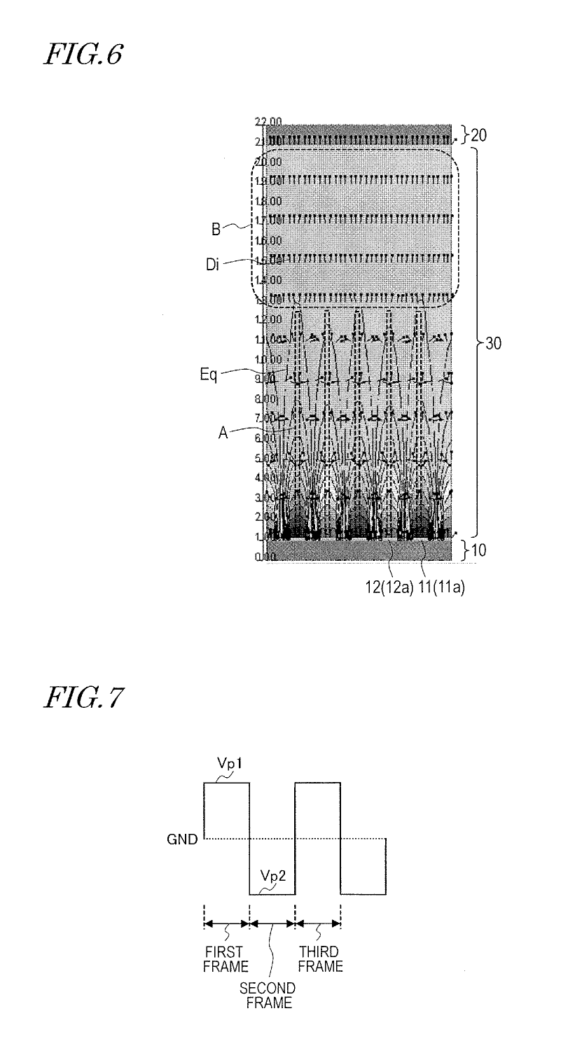

FIG. 6 shows the result of a simulation of the alignment of liquid crystal molecules in the presence of a lateral field applied across the optical layer 30. In FIG. 6, the alignment direction (director) Di of the liquid crystal molecules and equipotential lines Eq in the presence of an applied lateral field are shown. When the liquid crystal material that is the medium 31 is of a positive type, the change of the alignment direction of the anisotropically-shaped particles 32 follows the change of the alignment direction of the liquid crystal molecules. Therefore, the director Di can be regarded as the alignment direction of the anisotropically-shaped particles 32. Note that Expert LCD manufactured by JEDAT Inc. was used in the simulation. The simulation parameters were as shown in Table 1 below.

TABLE 1

| | | |
|---|---|---|
| LIQUID CRYSTAL MATERIAL | ne | 1.6010 |
| | no | 1.4796 |
| | Δn | 0.1214 |
| | ε// | 24.7 |
| | ε⊥ | 4.3 |
| | Δε | 20.4 |

| | | |
|---|---|---|
| γ1 | 163 | mPa · s |
| K1 | 12.1 | pN |
| K3 | 13.9 | pN |

| | |
|---|---|
| OPTICAL LAYER THICKNESS | 20 μm |
| PRETILT ANGLE | 90° |

As shown in FIG. 6, no lateral field occurs in a region extending over the widthwise center of the branches 11a and 12a of the first electrode 11 and the second electrode 12. Therefore, the director Di does not change, and the liquid crystal molecules remain in a vertical alignment state. Further, since a lateral field does not reach the region B near the second substrate 20, the director Di does not change, and the liquid crystal molecules remain in a vertical alignment state. Therefore, in the above-described regions A and B, the anisotropically-shaped particles 32 remain in a vertical alignment state.

In view of the above-described problems, the present inventors wholeheartedly carried out extensive researches and found that, by applying across the optical layer 30 an oscillating voltage alternately including the first period in which the absolute value is relatively large and the second period in which the absolute value is relatively small, the proportion (probability of existence) of anisotropically-shaped particles 32 whose alignment direction changes in response to application of the voltage can be increased. The following description is presented in comparison with the display device 610 of the comparative example in which simple alternate driving is performed.

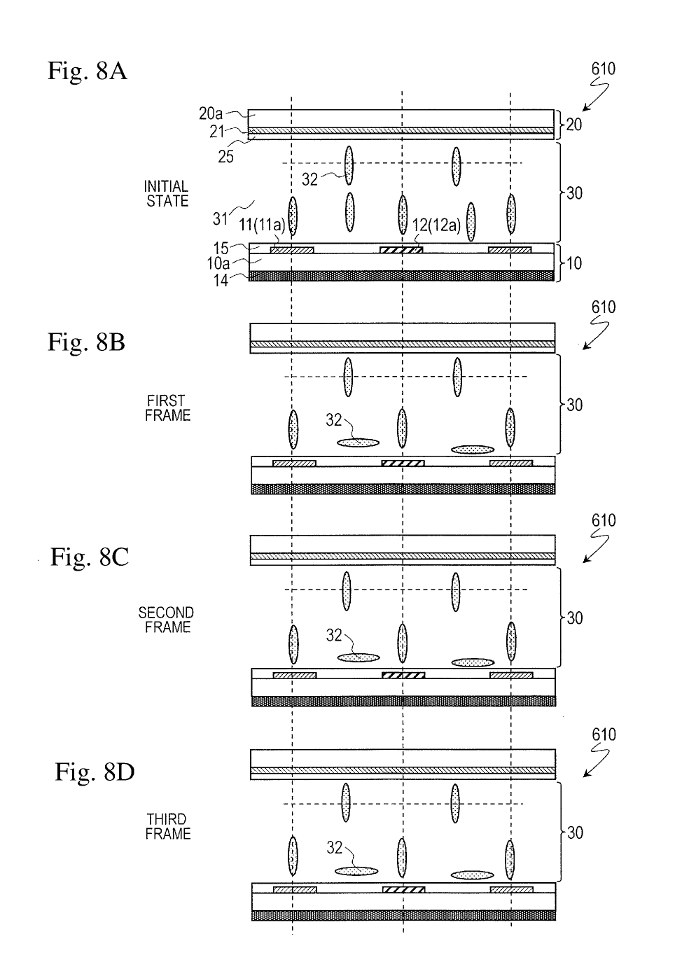

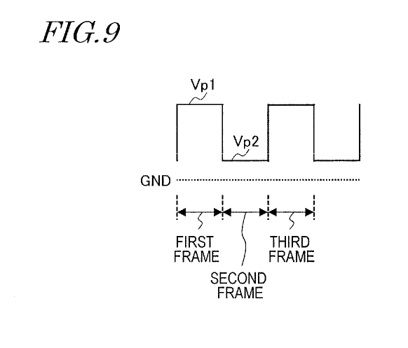

FIG. 7 shows the waveform of an AC voltage applied across the optical layer 30 of the display device 610 of the comparative example. FIGS. 8(a) to 8(d) show alignment states of the anisotropically-shaped particles 32 which may appear when an AC voltage which has the waveform shown in FIG. 7 is applied as the lateral field across the optical layer 30 of the display device 610 of the comparative example. FIG. 7 shows a voltage waveform in the case where the display device 610 performs displaying at the same grayscale level (which is, as a matter of course, different from the lowest grayscale level) over a plurality of frames. FIGS. 8(a) to 8(d) show alignment states in the initial state (i.e., in the absence of an applied voltage) and in the first, second and third frames, respectively. In FIGS. 8(a) to 8(d), some of the components of the display device 610 of the comparative example which have the same functions as those of the display device 110 are designated by the same reference numerals.

The AC voltage shown in FIG. 7 is a rectangular wave in which one cycle consists of two frames (i.e., two vertical scan periods). In this rectangular wave, two types of periods which have the same absolute value but opposite polarities alternately occur. That is, the absolute value of voltage Vp1 in the odd-numbered frames (the first frame, the third frame, . . . ) is equal to the absolute value of voltage Vp2 in the even-numbered frames (the second frame, the fourth frame, . . . ), and the polarity reverses every frame.

In the display device 610 of the comparative example, as shown in FIGS. 8(b) to 8(d), the alignment direction of the anisotropically-shaped particles 32 does not change in a region extending over the widthwise center of the branches 11a and 12a of the first electrode 11 and the second electrode 12 and in a region near the second substrate 20.

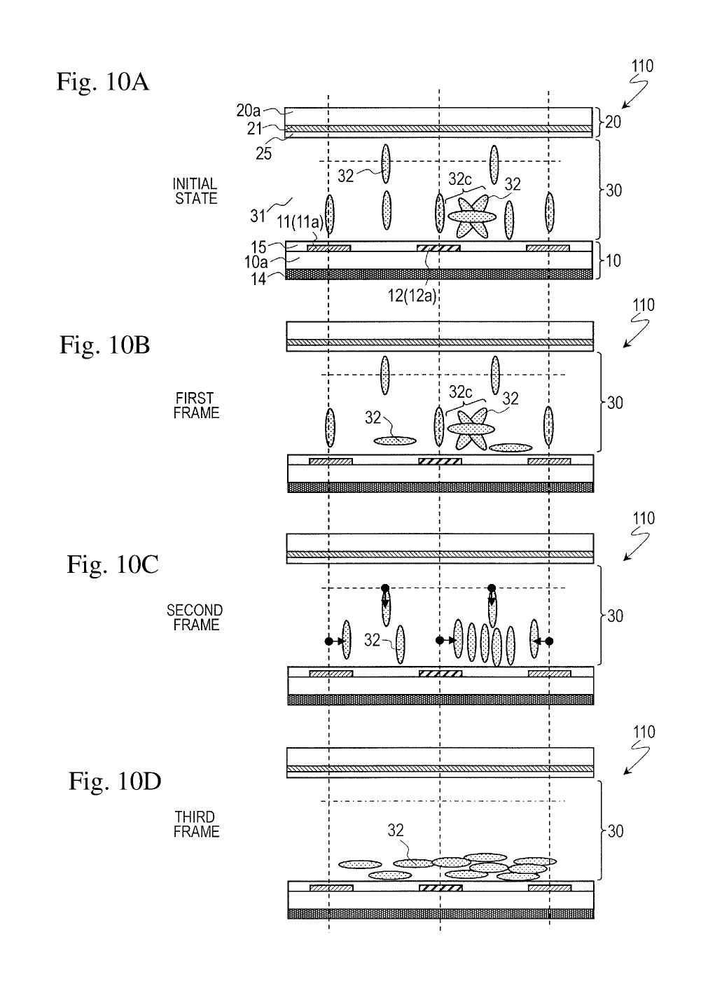

FIG. 9 shows the waveform of an oscillating voltage applied across the optical layer 30 of the display device 110 of the present embodiment. FIGS. 10(a) to 10(d) show alignment states of anisotropically-shaped particles 32 which may appear when an oscillating voltage which has the waveform shown in FIG. 9 is applied as the lateral field across the optical layer 30 of the display device 110 of the present embodiment. FIG. 9 shows a voltage waveform in the case where the display device 110 performs displaying at the same grayscale level (which is, as a matter of course, different from the lowest grayscale level) over a plurality of frames. FIGS. 10(a) to 10(d) show the alignment states in the initial state (i.e., in the absence of an applied voltage) and in the first, second and third frames, respectively.

The oscillating voltage shown in FIG. 9 is a rectangular wave in which one cycle consists of two frames (i.e., two vertical scan periods), and alternately includes the first period in which the absolute value is relatively large and the second period in which the absolute value is relatively small. The absolute value of voltage Vp1 in the odd-numbered frames (the first frame, the third frame, . . . ), which are the first periods, is greater than the absolute value of voltage Vp2 in the even-numbered frames (the second frame, the fourth frame, . . . ), which are the second periods. In the example shown in FIG. 9, voltage Vp1 in the first period and voltage Vp2 in the second period are both greater than 0 V (ground potential GND). Thus, the polarity does not reverse every frame.

In the first frame, as shown in FIG. 10(b), voltage Vp1 which is relatively large is applied across the optical layer 30, so that the alignment direction of the anisotropically-shaped particles 32 changes, so that the anisotropically-shaped particles 32 fall into a horizontal alignment state. Also, unshown liquid crystal molecules fall into a state where the horizontal alignment component is increased. Note that, however, meanwhile, the alignment direction of the anisotropically-shaped particles 32 in a region of small electric field intensity does not change.

In the second frame, voltage Vp2 which is relatively small is applied across the optical layer 30, so that the liquid crystal molecules in a state where the horizontal alignment component is increased change their alignment direction so as to fall into a vertical alignment state again. This change of the alignment direction (oscillation of liquid crystal molecules) is a swinging phenomenon of the medium 31. Due to this, as shown in FIG. 10(c), the anisotropically-shaped particles 32 in a region of small electric field intensity move to a region of large electric field intensity. Also, due to the above-described swinging phenomenon, the coagulated anisotropically-shaped particles 32 are disentangled from the state of coagulation.

In the third frame, large voltage Vp1 is again applied across the optical layer 30. In this frame, a larger number of anisotropically-shaped particles 32 are in a horizontal alignment state than in the first frame because the anisotropically-shaped particles 32 in a region of small electric field intensity have moved to a region of large electric field intensity in the second frame. Meanwhile, the anisotropically-shaped particles 32 disentangled from the state of coagulation are also in a horizontal alignment state.

As described above, in the display device 110 of the present embodiment, an oscillating voltage, which alternately includes the first period in which the absolute value is relatively large and the second period in which the absolute value is relatively small, is applied across the optical layer 30, whereby not only the alignment direction of the anisotropically-shaped particles 32 in a region of large electric field intensity but also the alignment direction of the anisotropically-shaped particles 32 which has originally been in a region of small electric field intensity can be changed. Therefore, the degree of change in an optical characteristic (light reflectance) can be sufficiently increased, and brighter displaying can be realized.

To cause the medium 31 to swing more strongly such that a larger number of anisotropically-shaped particles 32 move from a region of small electric field intensity, it is preferred that the absolute value of the oscillating voltage in the second period, Vp2, is not more than 50% of the absolute value of the oscillating voltage in the first period, Vp1. Further, it is preferred that the oscillating voltage in the second period, Vp2, is about 0 V as shown in FIG. 11. Due to the oscillating voltage in the second period, Vp2, which is about 0 V, the medium 31 can swing in the strongest manner. When the medium 31 is a liquid crystal material as in the present embodiment, the director Di can achieve the largest change.

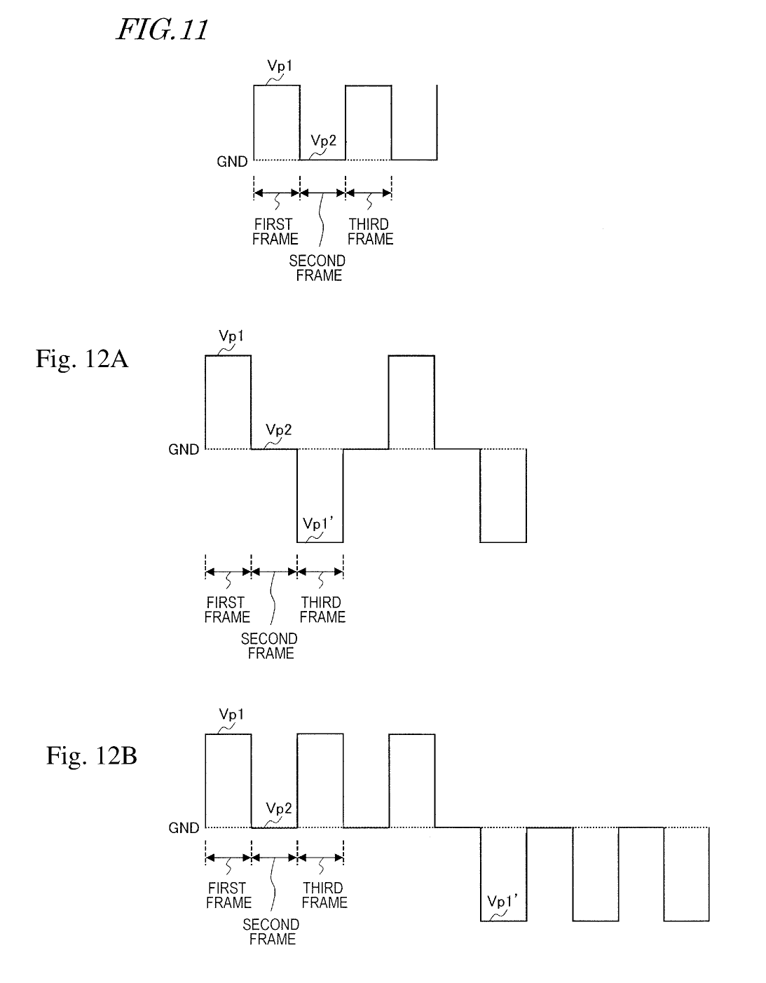

The waveform of the oscillating voltage applied across the optical layer 30 is not limited to those illustrated in FIG. 9 and FIG. 11. For example, an oscillating voltage which has the waveforms shown in FIGS. 12(a) and 12(b) may be applied across the optical layer 30.

The oscillating voltages shown in FIGS. 12(a) and 12(b) are rectangular waves in which one cycle consists of four frames (four vertical scan periods) and twelve frames (twelve vertical scan periods), respectively, and alternately include the first period in which the absolute value is relatively large and the second period in which the absolute value is relatively small. In the example shown in FIG. 12(a), the oscillating voltage in a certain first period (e.g., the first frame), Vp1, and the oscillating voltage in another first period (e.g., the third frame), Vp1′, have opposite polarities. Also in the example shown in FIG. 12(b), the oscillating voltage in a certain first period (e.g., the first frame), Vp1, and the oscillating voltage in another first period (e.g., the seventh frame), Vp1′, have opposite polarities. That is, in the examples shown in FIGS. 12(a) and 12(b), the oscillating voltages have polarity-reversed components. Therefore, deterioration of the medium 31 which is attributed to continuous application of voltages of the same polarity can be suppressed. The timing of reversing the polarity is not particularly limited. From the viewpoint of surely suppressing deterioration of the medium 31, it is preferred that the interval of the polarity reversal is as short as possible. As shown in FIG. 12(a), a first period in which the voltage is of the positive polarity and a first period in which the voltage is of the negative polarity alternately occur with a second period interposed therebetween. Further, since the moving direction of the anisotropically-shaped particles 32 (horizontal and/or vertical moving direction) can be reversed by the polarity reversal, the extent of moving of the anisotropically-shaped particles 32 can also be advantageously increased.

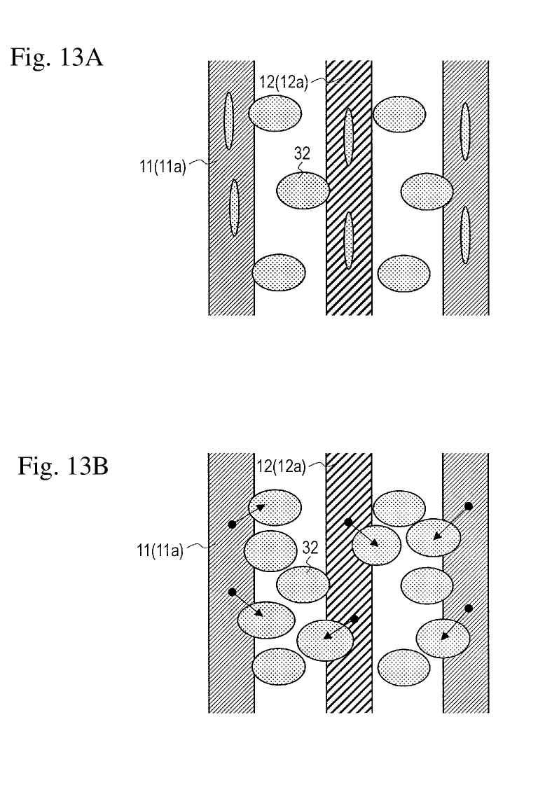

When a lateral field is applied as the oscillating voltage across the optical layer 30 as in the present embodiment, moving the anisotropically-shaped particles 32 in a region of small electric field intensity in the in-plane direction of the optical layer 30 as shown in FIGS. 13(a) and 13(b) is easy. The probability of existence of anisotropically-shaped particles 32 whose alignment direction changes in the layer plane (here, falling into a horizontal alignment state) can be increased. FIG. 13(a) is a plan view showing an alignment state of the anisotropically-shaped particles 32 which may appear immediately after a lateral field is applied as the oscillating voltage across the optical layer 30 (corresponding to FIG. 10(b)). FIG. 13(b) is a plan view showing an alignment state of the anisotropically-shaped particles 32 which may appear during a period where a large voltage is applied again across the optical layer 30 after passage of a period of small applied voltage (corresponding to FIG. 10(d)).

In a configuration where a lateral field can be applied as the oscillating voltage across the optical layer (i.e., a configuration where the first electrode 11 and the second electrode 12 are provided on the first substrate 10 side), it is preferred that the width w₁ of the branches 11a of the first electrode 11 and the width w₂ of the branches 12a of the second electrode 12 are each smaller than the interelectrode distance g. That is, it is preferred that the relationships of w₁<g and w₂<g are satisfied. As previously described, there is a region over the branches 11a and 12a in which no lateral field is produced. Therefore, by relatively decreasing the widths w₁ and w₂ of the branches 11a and 12a and relatively increasing the interelectrode distance g, the proportion of the region in which a lateral field is produced can be increased, and the lateral field can affect a larger number of anisotropically-shaped particles 32.

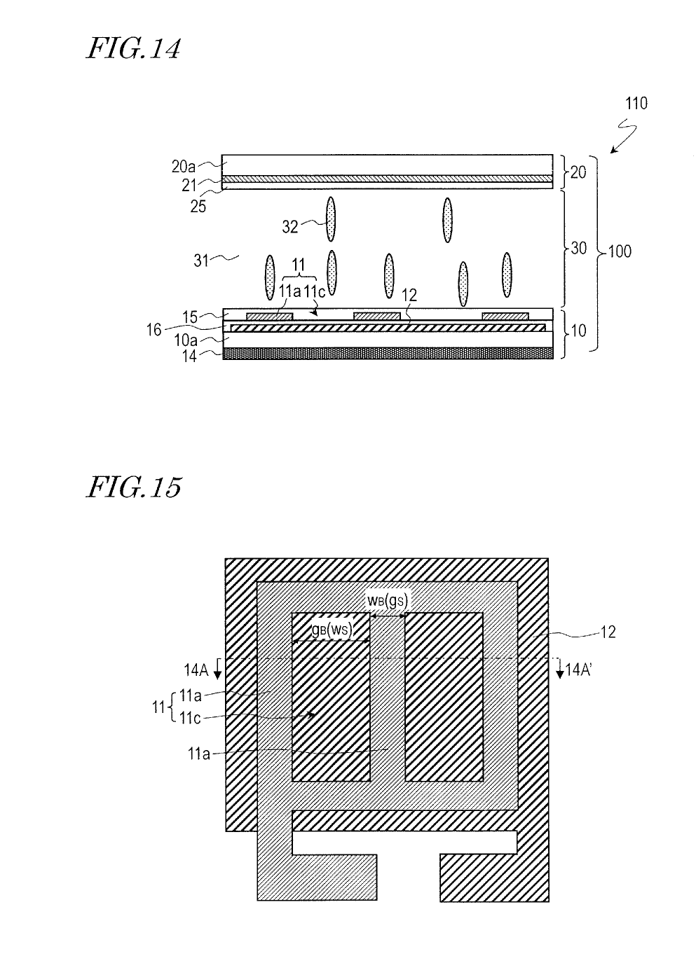

Although the foregoing description has been presented with the example of the electrode structure shown in FIG. 1 and FIG. 2, the electrode structure of the display panel 100 is not limited to this example. For example, an electrode structure such as shown in FIG. 14 and FIG. 15 may be used.

In the example shown in FIG. 1 and FIG. 2, the first electrode 11 and the second electrode 12 are provided at the same level (height). On the other hand, in the example shown in FIG. 14 and FIG. 15, the first electrode 11 and the second electrode 12 are provided at different levels. Specifically, as shown in FIG. 14, the first substrate 10 includes an insulator layer (dielectric layer) 16 provided on the second electrode 12, and the first electrode 11 is provided on this insulator layer 16. That is, in this example, the first substrate 10 includes the first electrode 11, the insulator layer 16 and the second electrode 12 in this order from the optical layer 30 side.

The first electrode 11 has a plurality of branches 11a and a plurality of slits 11c. The second electrode 12 has no slits and is provided so as to cover almost entire pixel region (i.e., a so-called spread electrode).

Even when the electrode structure shown in FIG. 14 and FIG. 15 is used, a lateral field can be produced across the optical layer 30 by applying a predetermined voltage between the first electrode 11 and the second electrode 12. When the electrode structure shown in FIG. 14 and FIG. 15 is used, it is preferred that the width of the branches 11a of the first electrode 11, w_{B}, and the distance between two adjoining branches 11a, g_{B}, satisfy the relationship of w_{B}<g_{B}. In other words, it is preferred that the width of the slit 11c, w_{S}, and the distance between two adjoining slits 11c, g_{S}, satisfy the relationship of w_{S}>g_{S}.

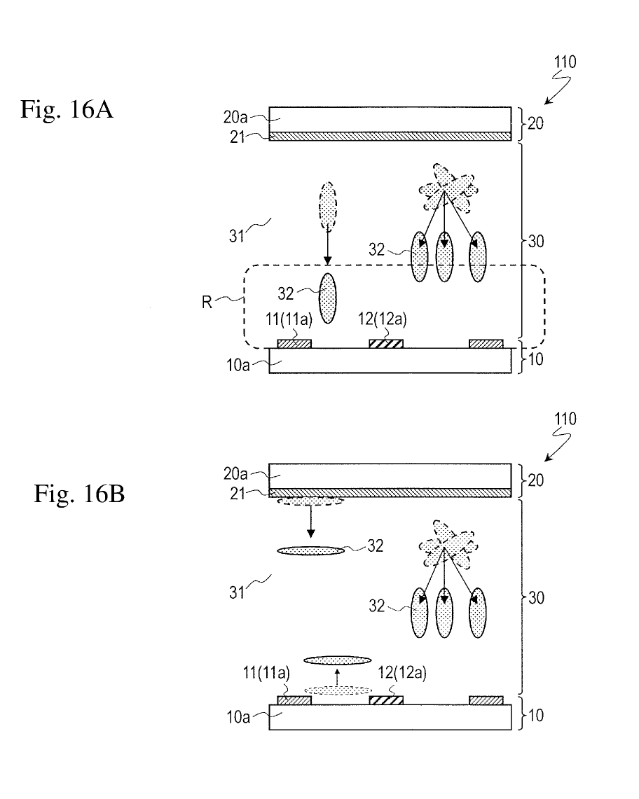

A longitudinal field may be applied as the oscillating voltage across the optical layer 30. When a longitudinal field is applied as the oscillating voltage across the optical layer 30, the anisotropically-shaped particles 32 in a region of small electric field intensity can be easily moved in a direction normal to the optical layer 30. For example, as illustrated in FIG. 16(a), the anisotropically-shaped particles 32 can be moved into a region R on which a lateral field effectively acts. Further, as illustrated in FIG. 16(b), anisotropically-shaped particles 32 adhering on the substrate can be moved to the central part of the optical layer 30. Further, as shown in FIGS. 16(a) and 16(b), the effect of disentangling the coagulated anisotropically-shaped particles 32 from the state of coagulation can also be achieved.

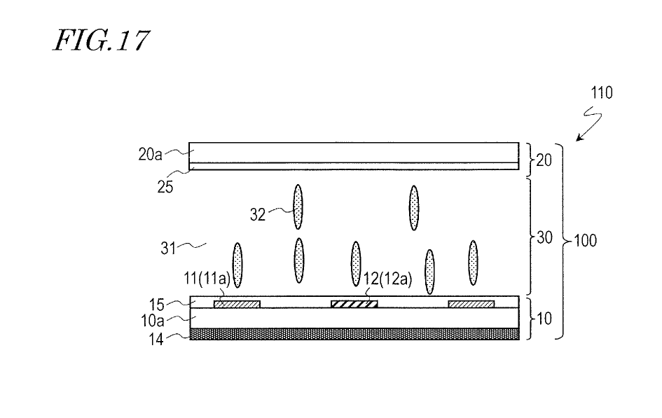

Although in the present embodiment the third electrode 21 is provided on the second substrate 20 side, the third electrode 21 on the second substrate 20 side may be omitted as shown in FIG. 17. This is because the anisotropically-shaped particles 32 are in a vertical alignment state when no voltage is applied across the optical layer 30. Note that, however, from the viewpoint of the response speed, it is preferred to use a configuration where the third electrode 21 is provided on the second substrate 20 side (i.e., a configuration where a longitudinal field is applied across the optical layer 30). That is, it is preferred that displaying is performed by switching between a state where a longitudinal field is produced across the optical layer 30 and a state where a lateral field is produced across the optical layer 30. Transition from the former state to the latter state and transition from the latter state to the former state are both realized by changing the direction of an applied electric field, and therefore, a sufficient response speed can be realized.

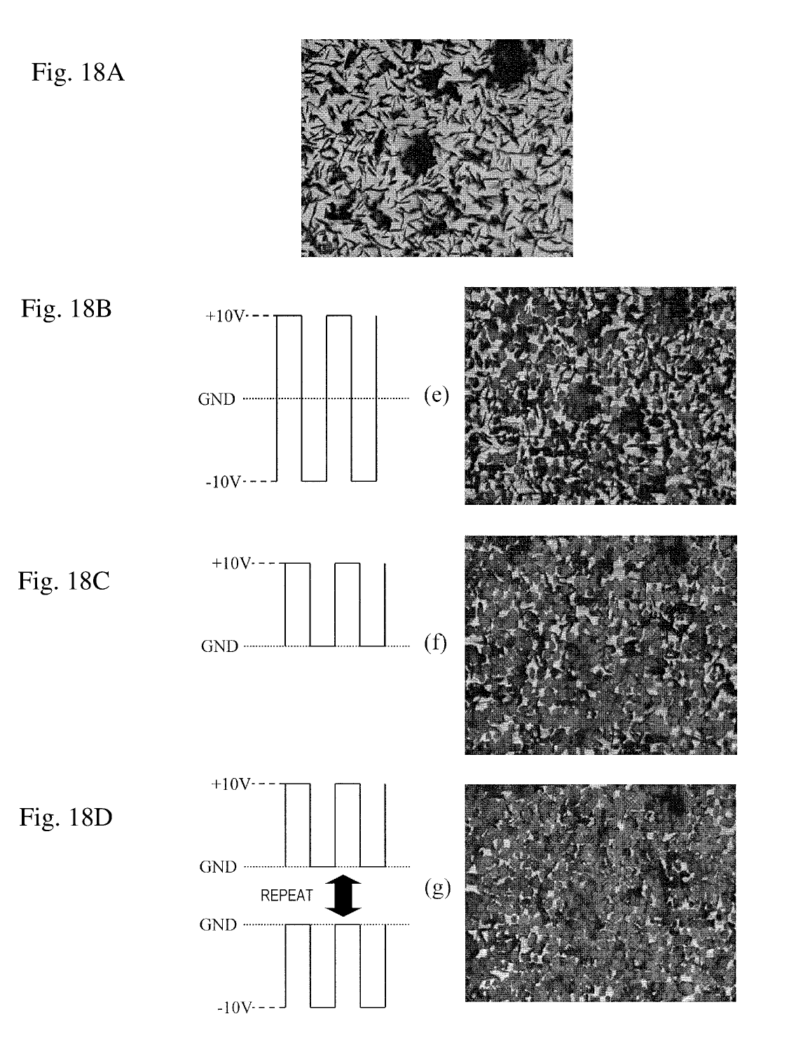

Now, the results of a verification that the proportion (probability of existence) of anisotropically-shaped particles 32 whose alignment direction changes can be increased by application of an oscillating voltage such as that described above are described with reference to FIGS. 18(a) to 18(g). FIG. 18(a) is an optical microscopic image of the optical layer 30 in the absence of an applied voltage. FIGS. 18(b) to 18(d) show the waveforms of voltages applied across the optical layer 30. FIGS. 18(e) to 18(g) are optical microscopic images of the optical layer 30 in the presence of applied voltages which have the waveforms shown in FIGS. 18(b) to 18(d), respectively. Note that the optical microscopic images of FIG. 18(a) and FIGS. 18(e) to 18(g) were obtained by observation of the optical layer 30 from the first substrate 11 side.

As shown in FIG. 18(a), when no voltage is applied across the optical layer 30, the anisotropically-shaped particles 32 are in a vertical alignment state.

When a simple AC voltage shown in FIG. 18(b) (Vp1=+10 V, Vp2=−10 V) is applied across the optical layer 30, some of the anisotropically-shaped particles 32 are in a horizontal alignment state while the other anisotropically-shaped particles 32 remain in a vertical alignment state as shown in FIG. 18(e).

On the other hand, when the oscillating voltage shown in FIG. 18(c) (Vp1=+10 V, Vp2=0 V) is applied across the optical layer 30, a large number of anisotropically-shaped particles 32 are in a horizontal alignment state as shown in FIG. 18(f).

When two types of oscillating voltages shown in FIG. 18(d) (an oscillating voltage of Vp1=+10 V, Vp2=0 V and an oscillating voltage of Vp1=−10 V, Vp2=0 V) are alternately and repeatedly applied across the optical layer 30 (i.e., polarity reversal is carried out), still more anisotropically-shaped particles 32 are in a horizontal alignment state as shown in FIG. 18(g).

As described above, it was verified that the proportion (probability of existence) of anisotropically-shaped particles 32 whose alignment direction changes can be increased by applying across the optical layer 30 an oscillating voltage alternately including the first period in which the absolute value is relatively large and the second period in which the absolute value is relatively small.

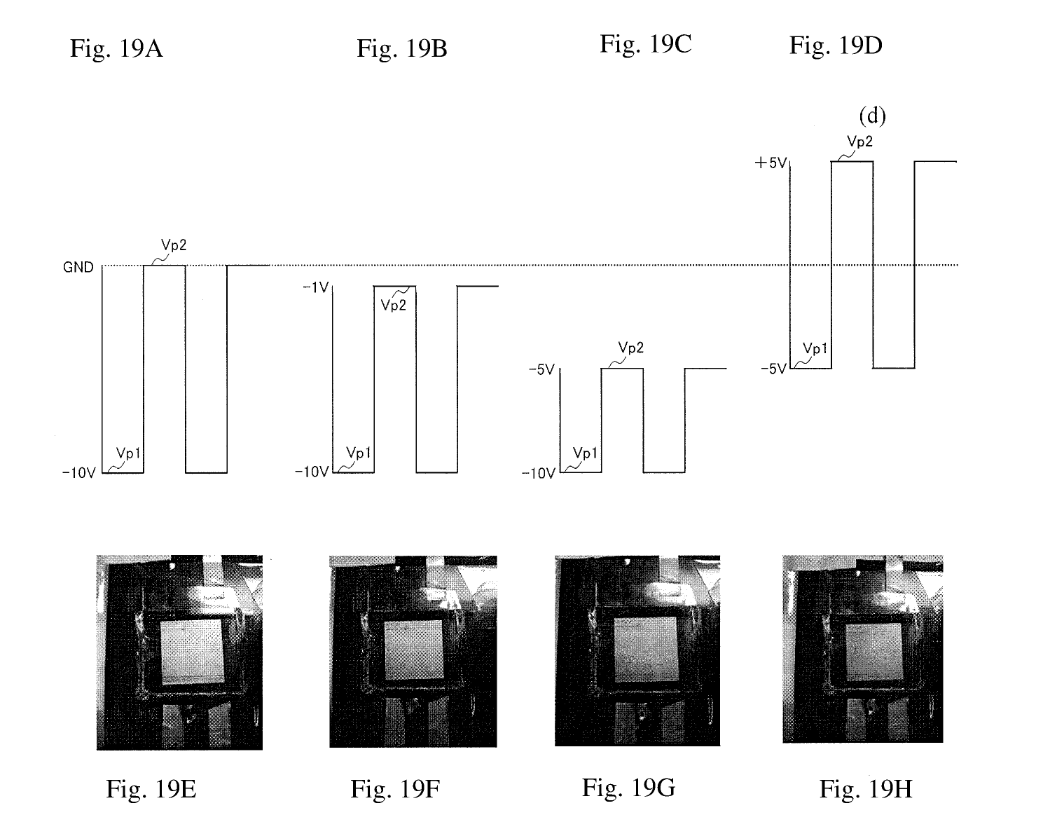

The peak-to-peak voltage value (peak-to-peak value) of the oscillating voltage is preferably greater than 50% of the peak-to-peak voltage value of an AC voltage which is used in the case where simple alternate driving is performed. Hereinafter, the results of verification conducted as to the relationship between the peak-to-peak voltage value of the oscillating voltage and the display brightness are described with reference to FIG. 19. FIGS. 19(a) to 19(d) show the voltage waveforms. FIGS. 19(e) to 19(h) are photographs of the display device in the case where voltages having the waveforms shown in FIGS. 19(a) to 19(d) were applied across the optical layer 30. Note that, in the verification, in a trial product display device, the second electrode 12 and the third electrode 21 were at the ground potential, and voltages having the waveforms shown in FIGS. 19(a) to 19(d) were input from a function generator to the first electrode 11. The driving frequency was 60 Hz. The photographs shown in FIGS. 19(e) to 19(h) were taken under the same exposure condition.

FIG. 19(a) shows an oscillating voltage whose peak-to-peak voltage value is 10 Vpp (Vp1=−10 V, Vp2=0 V). FIG. 19(b) shows an oscillating voltage whose peak-to-peak voltage value is 9 Vpp (Vp1=−10 V, Vp2=−1 V). FIG. 19(c) shows an oscillating voltage whose peak-to-peak voltage value is 5 Vpp (Vp1=−10 V, Vp2=−5 V). FIG. 19(d) shows an AC voltage whose peak-to-peak voltage value is 10 Vpp (Vp1=5 V, Vp2=+5 V).

As seen from the comparison between FIG. 19(g) and FIG. 19(h), the brightness achieved in the case of the oscillating voltage shown in FIG. 19(c) whose peak-to-peak voltage value is 5 Vpp is equal to that achieved in the case of the AC voltage shown in FIG. 19(d) whose peak-to-peak voltage value is 10 Vpp.

As seen from the comparison between FIG. 19(f) and FIG. 19(h), the display brightness achieved in the case of the oscillating voltage shown in FIG. 19(b) whose peak-to-peak voltage value is 9 Vpp is about 15% to 25% higher than that achieved in the case of the AC voltage shown in FIG. 19(d).

As seen from the comparison between FIG. 19(e) and FIG. 19(h), the display brightness achieved in the case of the oscillating voltage shown in FIG. 19(a) whose peak-to-peak voltage value is 10 Vpp is about 20% to 30% higher than that achieved in the case of the AC voltage shown in FIG. 19(d).

As seen from the above-described results of verification, the peak-to-peak voltage value of the oscillating voltage is greater than 50% of the peak-to-peak voltage value of an AC voltage which is used in the case where simple alternate driving is performed, and therefore, high display brightness can be achieved as compared with the case where simple alternate driving is performed.

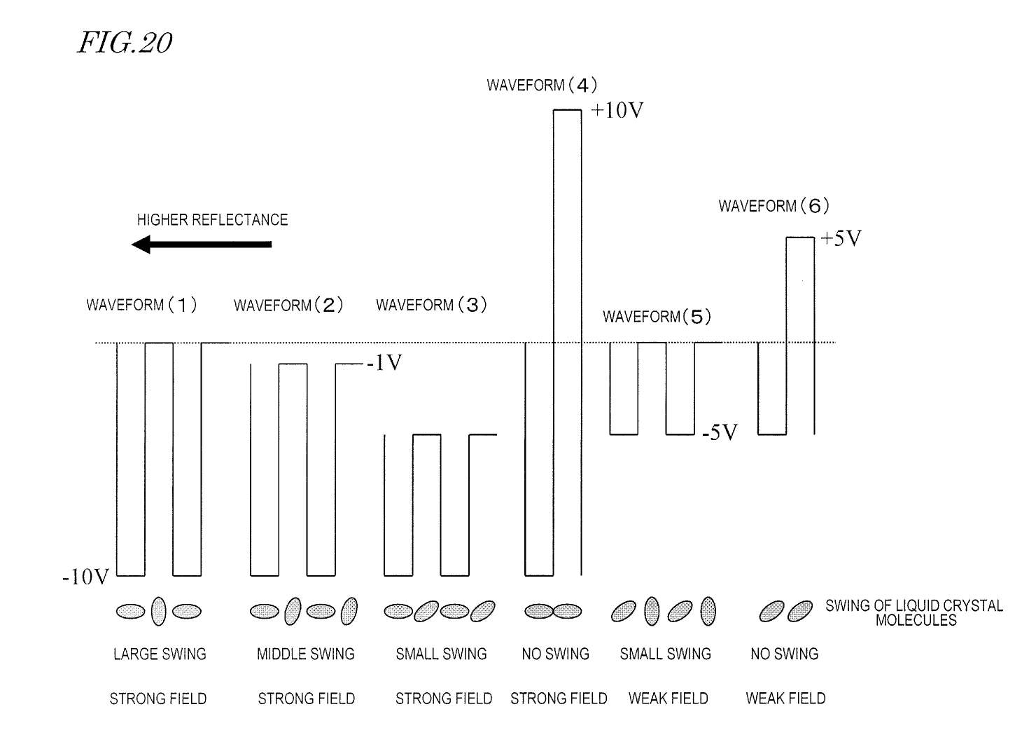

FIG. 20 shows the relationship between various voltage waveforms and the reflectance. FIG. 20 shows six waveforms (1) to (6). Waveform (1) represents an oscillating voltage whose peak-to-peak voltage value is 10 Vpp (Vp1=−10 V, Vp2=0 V) (corresponding to FIG. 19(a)). Waveform (2) represents an oscillating voltage whose peak-to-peak voltage value is 9 Vpp (Vp1=−10 V, Vp2=−1 V) (corresponding to FIG. 19(b)). Waveform (3) represents an oscillating voltage whose peak-to-peak voltage value is 5 Vpp (Vp1=−10 V, Vp2=−5 V) (corresponding to FIG. 19(c)). Waveform (4) represents an AC voltage whose peak-to-peak voltage value is 20 Vpp (Vp1=10 V, Vp2=+10 V). Waveform (5) represents an oscillating voltage whose peak-to-peak voltage value is 5 Vpp (Vp1=−5 V, Vp2=0 V). Waveform (6) represents an AC voltage whose peak-to-peak voltage value is 10 Vpp (Vp1=−5 V, Vp2=+5 V) (corresponding to FIG. 19(d)).

FIG. 20 shows that a waveform which is closer to the left side of the drawing has higher reflectance according to principles. That is, the reflectance increases as the degree of the swing of liquid crystal molecules increases (i.e., as the difference between the absolute values of Vp1 and Vp2 increases) or as the intensity of the electric field increases (i.e., as the absolute value of Vp1 (and Vp2) increases).

As seen from waveforms (3) and (6) of FIG. 20, the display brightness is supposed to be better when the oscillating voltage shown in FIG. 19(c) is applied than when the AC voltage shown in FIG. 19(d) is applied. The reasons why the verification results previously described with reference to FIG. 19 belie this supposition are estimated to be that, in a trial product display device, almost all of anisotropically-shaped particles 32 on which a lateral field effectively act even with a voltage of about 5 V fell into a horizontal alignment, and that the effect of the swing of liquid crystal molecules was not sufficient (the peak-to-peak voltage value was not sufficient for disentangling the particles from the coagulation).

When an oscillating voltage such as described above is applied, an alignment regulating force acts on the anisotropically-shaped particles 32 such that the anisotropically-shaped particles 32 restore a vertical alignment state in the second period. However, decrease in brightness due to that restoration does not matter. This is because the response speed of the anisotropically-shaped particles 32 is slower than that of the liquid crystal molecules, and therefore, the anisotropically-shaped particles 32 do not restore a vertical alignment state in the second period even when the second period is sufficiently long for swing of the medium 31 (e.g., one frame in 60 Hz driving).

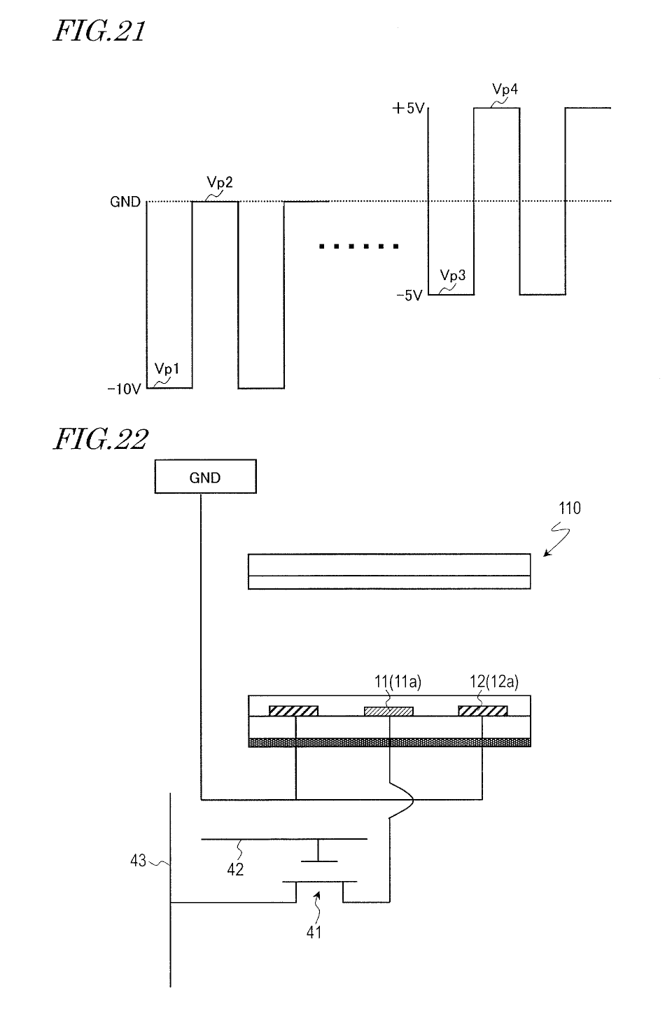

After being driven for a predetermined time period such that an oscillating voltage such as described above is applied, the display device may be switched to a normal alternate driving mode. FIG. 21 shows a voltage waveform example for a case where such a switch of the driving mode is carried out.

In the example of FIG. 21, an oscillating voltage shown in the left part of the drawing (Vp1=−10 V, Vp2=0 V) is applied across the optical layer 30 for a predetermined time period, and thereafter, an AC voltage shown in the right part of the drawing, alternately including the third period (Vp3=−5 V) and the fourth period (Vp4=+5 V) which have generally equal absolute values and which have opposite polarities, is applied across the optical layer 30.

Driving is carried out in such a manner that an oscillating voltage is applied, whereby anisotropically-shaped particles 32 of a region of small electric field intensity are moved so that the display is sufficiently bright, and then, the display device is switched to a normal alternate driving mode. Thereby, adherence of anisotropically-shaped particles 32 to the first substrate 10 is suppressed, so that the reliability can be improved. When, on the other hand, the above-described switching of the driving mode is not performed (i.e., the driving mode is maintained such that the oscillating voltage is applied), the driving can advantageously be simplified.

When the driving mode is switched as shown in FIG. 21, the duration of application of the oscillating voltage is preferably not less than 5 msec and not more than 5000 msec, more preferably not less than 5 msec and not more than 500 msec. Since the response speed of the anisotropically-shaped particles 32 is equal to or less than that of the liquid crystal molecules, the anisotropically-shaped particles 32 cannot be moved as desired if the duration of application of the oscillating voltage is excessively short (specifically, less than 5 msec). If the duration of application of the oscillating voltage is excessively long (specifically, more than 500 msec (particularly 5000 msec)), the anisotropically-shaped particles 32 adhere to the first substrate 10 and are unlikely to restore a vertical alignment state when application of a lateral field is stopped or when a longitudinal field is applied.

The display device 110 of the present embodiment is preferably driven at the frequency of not less than 1 Hz and not more than 300 Hz, more preferably not less than 1 Hz and not more than 100 Hz. If the frequency is excessively low (specifically, lower than 1 Hz), flicker is sometimes perceived. If the frequency is excessively high (specifically, higher than 100 Hz (particularly 300 Hz)), the change of alignment of the anisotropically-shaped particles 32 is sometimes unlikely to follow the change of the applied voltage.

Although in the present embodiment a liquid crystal material is used as the medium 31, the medium 31 may be any other material than the liquid crystal material so long as the swinging effect is achieved. The medium 31 is preferably a material which has high transparency to visible light. The viscosity of the medium 31 is preferably not more than 200 mPa·s from the viewpoint of response characteristics.

When the medium 31 is a liquid crystal material as in the present embodiment, efficient swing of the medium 31 can be achieved by utilizing the change of the director Di of the liquid crystal molecules. The liquid crystal material generally has a higher resistivity than propylene carbonate or the like by several orders of magnitude, and therefore, when the medium 31 is a liquid crystal material, occurrence of off-leakage via the medium 31 is prevented while a TFT is off after writing in a pixel. Thus, a high voltage retention rate is achieved, and active matrix driving can be suitably carried out. Further, the current leakage is small, and therefore, the power consumption can be reduced. The power consumption of the display device 110, P, is represented by the following formula (2).

P=C·V·f+I·V (2)

where C is the capacitance of the display panel 100, V is the voltage applied across the optical layer 30, f is the drive frequency, and I is the current leakage.

On the right side of formula (2), the first term is a term which is to be called a pixel capacitance term, and the second term is a term which is to be called a current leakage term. That is, the power consumption P can be separated into a pixel capacitance component and a current leakage component. When the resistivity of the medium 31 is high, the current leakage I decreases. Thus, as clearly seen from formula (2), the power consumption P can be reduced.

When the liquid crystal material is of a positive type as in the present embodiment, the behavior of the anisotropically-shaped particles 32 in the presence of an electric field applied across the optical layer 30 accords with the behavior of liquid crystal molecules 31. For example, when the electric field applied across the optical layer 30 is switched from a lateral field to a longitudinal field, the anisotropically-shaped molecules 32 tend to transition from a horizontal alignment state to a vertical alignment state, and the liquid crystal molecules 31a also tend to transition from a horizontal alignment state to a vertical alignment state. Thus, the number (probability of existence) of anisotropically-shaped particles 32 which are in a proper vertical alignment can be increased, and accordingly, a still higher contrast ratio can be realized.

As a positive type liquid crystal material, a wide range of liquid crystal materials for use in liquid crystal display devices can be suitably used. For example, a fluorine-type liquid crystal material having fluorine introduced in a side chain thereof can be suitably used. Fluorine-type liquid crystal materials, which are often used in passive matrix-driven liquid crystal display devices, have large dielectric anisotropy and high resistivity. Specifically, for example, a liquid crystal material whose dielectric constant ∈_{//} along the major axis direction is 24.7, dielectric constant ∈_{⊥} along the minor axis direction is 4.3, and resistivity ρ is 6×10¹³ Ω·cm can be used. It will be appreciated that the dielectric constant and resistivity of the liquid crystal material are not limited to those mentioned here. From the standpoint of sufficiently restraining an off-leak from occurring via the medium 31, the resistivity of the liquid crystal material is preferably 1×10¹¹ to ¹² Ω·cm or more. Moreover, the dielectric anisotropy Δ∈ of the liquid crystal material is preferably greater than 10 (Δ∈>10).

The medium 31 used may be a liquid crystal material which has negative dielectric anisotropy (i.e., a negative-type liquid crystal material).

In the present embodiment, when no voltage is applied across the optical layer 30, the anisotropically-shaped particles 32 orient generally perpendicular to the substrate plane. Therefore, the change of the alignment direction of the anisotropically-shaped particles 32 which occurs when a voltage (lateral field) is applied is large so that efficient swing of the medium 31 can be achieved. Further, due to the presence of an alignment regulating force which causes the anisotropically-shaped particles 32 to orient generally perpendicular to the substrate plane when no voltage is applied across the optical layer 30, the anisotropically-shaped particles 32 are prevented from adhering to the alignment film while they are in a horizontal state.

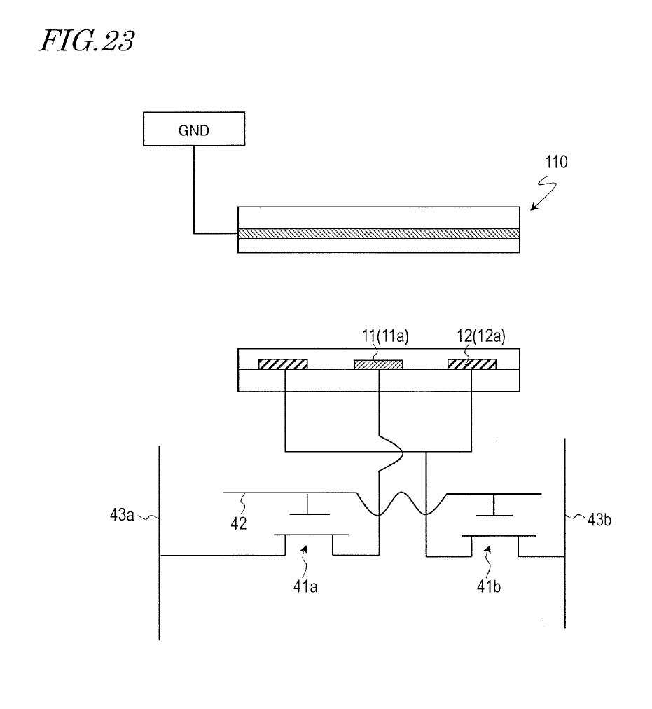

As previously described, a construction where the medium 31 is a liquid crystal material is capable of suitably performing active matrix driving. FIG. 22 and FIG. 23 show the interconnection between electrodes, TFTs, and wires in the case where active matrix driving is performed. FIG. 22 shows the interconnection in a construction where the third electrode 21 is not provided on the second substrate 20 side as shown in FIG. 17. FIG. 23 shows the interconnection in a construction where the third electrode 21 is provided on the second substrate 20 side as shown in FIG. 1, for example.

In the construction shown in FIG. 22, each pixel includes a TFT 41. The gate electrode, the source electrode, and the drain electrode of the TFT 41 are electrically connected to a scan wire (gate wire) 42, a signal wire (source wire) 43, and the first electrode 11, respectively. The scan wire 42 supplies a scan signal (gate signal) to the TFT 41. The signal wire 43 supplies a display signal (source signal) to the TFT 41. A voltage corresponding to the display signal is applied to the first electrode 11 via the TFT 41. Meanwhile, a voltage which is common among a plurality of pixels (common voltage: here, ground potential) is applied to the second electrode 12.

In the construction shown in FIG. 23, each pixel includes a first TFT 41a and a second TFT 41b. The gate electrode, the source electrode, and the drain electrode of the first TFT 41a are electrically connected to a scan wire (gate wire) 42, a first signal wire (first source wire) 43a, and the first electrode 11, respectively. The gate electrode, the source electrode, and the drain electrode of the second TFT 41b are electrically connected to a scan wire (gate wire) 42, a second signal wire (second source wire) 43b, and the second electrode 12, respectively. The scan wire 42 supplies a scan signal (gate signal) to the first TFT 41a and the second TFT 41b. The first signal wire 43a supplies a first display signal (first source signal) to the first TFT 41a. The second signal wire 43b supplies a second display signal (second source signal) to the second TFT 41b. Voltages corresponding to the first display signal and the second display signal are applied to the first electrode 11 and the second electrode 12 via the first TFT 41a and the second TFT 41b, respectively. Meanwhile, a voltage which is common among a plurality of pixels (common voltage: here, ground potential) is applied to the third electrode 21.

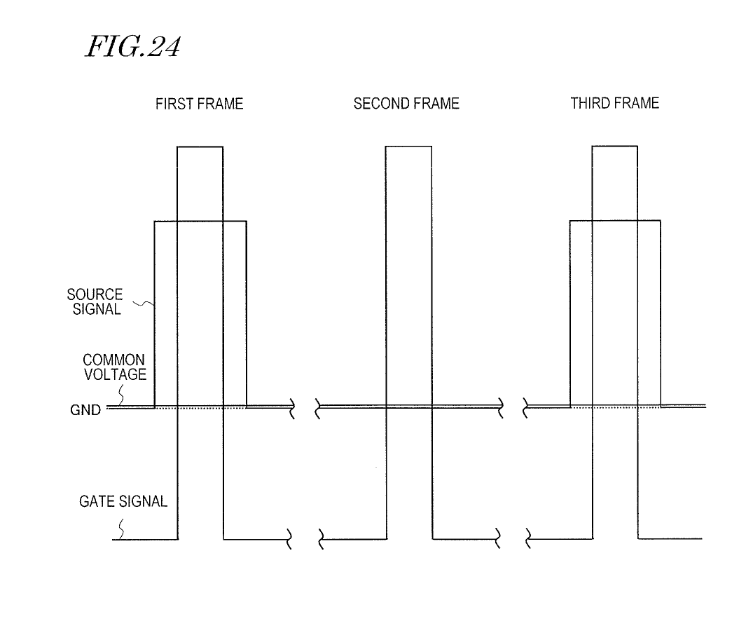

FIG. 24 shows the voltage waveforms of the gate signal, the source signal and the common voltage in the construction shown in FIG. 22. As shown in FIG. 23, in each frame, a high-level signal (ON voltage) is supplied as the gate signal to the TFT 41. The source signal supplied to the TFT 41 (and the first electrode 11 that is electrically connected to the drain electrode of the TFT 41) is a voltage of a large absolute value in odd-numbered frames and a voltage of a small absolute value in even-numbered frames. A voltage which is always at the same level (ground potential) is supplied to the second electrode 12.

There is no particular limitation as to the specific shape and material of the anisotropically-shaped particles 32, so long as their projected area onto the substrate plane changes in accordance with an applied voltage (the direction of an applied field) in the manner described above. The anisotropically-shaped members 32 may be in flake form (thin-strip shaped), or cylindrical or ellipsoidal form, etc. From the viewpoint of improving the effect of moving the anisotropically-shaped particles 32 by means of swing of the medium 31, the anisotropically-shaped particles 32 preferably have such a shape that the resistance during moving of the particles is as small as possible (for example, a cylindrical shape and an ellipsoidal shape are preferred rather than a flake-like shape). From the standpoint of realizing a high contrast ratio, preferably the anisotropically-shaped particles 32 are shaped so that the ratio between the maximum projected area and the minimum projected area is 2:1 or more.

As the material of the anisotropically-shaped particles 32, metal material, a semiconductor material, a dielectric material, or a composite material thereof can be used. The anisotropically-shaped particles 32 may be a multilayer dielectric film, or composed of a cholesteric resin material. In the case where a metal material is used as the material of the anisotropically-shaped particles 32, an insulating layer (dielectric layer) is preferably formed on the surface of the anisotropically-shaped particles 32. Although the dielectric constant of a metal alone would be an imaginary number, forming an insulating layer (e.g., a resin layer or a metal oxide layer) on its surface will allow the anisotropically-shaped particles 32 made of the metal material to be treated as a dielectric. An insulating layer being formed on the surface will also provide the effects of preventing electrical conduction due to contact between anisotropically-shaped particles 32 being made of the metal material, coagulation due to physical interactions, and so on. As such anisotropically-shaped particles 32, for example, aluminum flakes whose surface is coated with a resin material (e.g., an acrylic resin) can be used. The optical layer 30 has an aluminum flake content of e.g., 3 weight %. Alternatively, aluminum flakes having an SiO₂ layer formed on their surface, aluminum flakes having an aluminum oxide layer formed on their surface, and so on can also be used. It will be appreciated that metal materials other than aluminum may also be used as the metal material. Moreover, the anisotropically-shaped particles 32 may be colored.

The length of the anisotropically-shaped particles 32 is not particularly limited but is preferably not less than 4 μm and not more than 10 μm. If the length of the anisotropically-shaped particles 32 is more than 10 μm, the anisotropically-shaped particles 32 are sometimes unlikely to move. On the other hand, if the length of the anisotropically-shaped particles 32 is less than 4 μm, manufacture of the anisotropically-shaped particles 32 is sometimes difficult, or the reflective power of the anisotropically-shaped particles 32 is sometimes insufficient. Moreover, in a reflection type display device such as that of the present embodiment, in order to cover the entire substrate plane with the anisotropically-shaped particles 32 in a horizontal alignment state for achieving high reflectance, it is preferable that the length of the anisotropically-shaped particles 32 is equal to or greater than the electrode pitch p. Also, there is no particular limitation as to the thickness of the anisotropically-shaped particles 32. However, the smaller the thickness of the anisotropically-shaped particles 32 is, the higher the transmittance of the optical layer 30 in a transparent state can be. Therefore, the thickness of the anisotropically-shaped particles 32 is preferably smaller than the interelectrode distance g (e.g., 4 μm or less), and more preferably equal to or less than the wavelength of light (e.g., 0.5 μm or less).

The specific gravity of the anisotropically-shaped particles 32 is preferably 11 g/cm³ or less, more preferably 3 g/cm³ or less, and further more preferably about the same specific gravity as that of the medium 31. This is because, if the specific gravity of the anisotropically-shaped particles 32 is significantly different from the specific gravity of the medium 31, a problem may occur in that the anisotropically-shaped particles 32 may precipitate or float around. From the viewpoint of improving the effect of moving the anisotropically-shaped particles 32 by means of swing of the medium 31, the anisotropically-shaped particles 32 are preferably light in weight.

As the vertical alignment films 15 and 25, vertical alignment films for use in VA (Vertical Alignment) mode liquid crystal display devices (e.g. polyimide-type or polyamic acid-type vertical alignment films manufactured by JSR CORPORATION or NISSAN CHEMICAL INDUSTRIES, LTD.) can be suitably used. In order to vertically align a positive type liquid crystal material having a high dielectric constant, it is preferable to use vertical alignment films having a hydrophobic structure such as an alkyl group or a fluorine-containing group relatively abundantly introduced in a side chain thereof. The vertical alignment films 15 and 25 each have a thickness of e.g. 100 nm. Of course, this is not a limitation.

Although the above description illustrates a construction where the first substrate 10 being an active matrix substrate is provided on the rear face side, the positioning of the first substrate 10 is not limited to this. The first substrate 10 may be provided on the front face side. The first substrate 10, being an active matrix substrate, contains component elements which are made of a material having light-shielding property; therefore, adopting a construction where the first substrate 10 is provided on the rear face side will make utmost use of the reflection effect of the anisotropically-shaped particles 32.

Although the foregoing description has been presented with the example of a reflective display device 110, the present invention is suitably applicable to transmissive display devices. In the transmissive display devices, a rear face side substrate does not include an optical absorption layer (the optical absorption layer 14 shown in, for example, FIG. 1). In the transmissive display devices, an illumination device for illuminating a display panel (backlight) is provided.

### INDUSTRIAL APPLICABILITY

According to an embodiment of the present invention, in an optical device including an optical layer which includes anisotropically-shaped particles, the proportion (probability of existence) of anisotropically-shaped particles whose alignment direction changes in response to application of a voltage can be increased. An optical device according to an embodiment of the present invention is suitably used as a display panel that is for use in display devices. An optical device according to an embodiment of the present invention is also used as various optical devices (e.g., optical switch) other than display panels.

### REFERENCE SIGNS LIST

10 first substrate
10a substrate
11 first electrode
11a branch of first electrode
11b stem of first electrode
12 second electrode
12a branch of second electrode
12b stem of second electrode
14 optical absorption layer
15, 25 vertical alignment film
16 insulator layer
20 second substrate
20a substrate
21 third electrode
30 optical layer (display medium layer)
31 medium (liquid crystal material)
32 anisotropically-shaped particles
41 thin film transistor (TFT)
41a first TFT
41b second TFT
42 scan wire (gate wire)
43 signal wire (source wire)
43a first signal wire
43b second signal wire
100 display panel (optical device)
110 display device

1. An optical device, comprising:
a first substrate and a second substrate opposing each other;
an optical layer interposed between the first substrate and the second substrate; and
a first electrode and a second electrode to which different potentials can be applied,
wherein the optical layer includes a medium and anisotropically-shaped particles dispersed in the medium, the anisotropically-shaped particles having shape anisotropy,
an alignment direction of the anisotropically-shaped particles changes depending on a voltage applied across the optical layer, and
the voltage applied across the optical layer is an oscillating voltage alternately including a first period in which an absolute value is relatively large and a second period in which an absolute value is relatively small.

2. The optical device of claim 1, wherein an absolute value of the oscillating voltage in the second period is not more than 50% of an absolute value of the oscillating voltage in the first period.

3. The optical device of claim 1, wherein an absolute value of the oscillating voltage in the second period is not more than 2% of a peak-to-peak voltage value of the oscillating voltage.

4. The optical device of claim 1, wherein the oscillating voltage in the second period is about 0 V.

5. The optical device of claim 1, wherein the oscillating voltage in a certain first period and the oscillating voltage in another first period have opposite polarities.

6. The optical device of claim 1 wherein, after the oscillating voltage is applied across the optical layer for a predetermined time period, the optical device can apply across the optical layer an AC voltage alternately including a third period and a fourth period which have generally equal absolute values and which have opposite polarities.

7. The optical device of claim 6, wherein the predetermined time period is not less than 5 msec and not more than 5000 msec.

8. The optical device of claim 6, wherein the predetermined time period is not less than 5 msec and not more than 500 msec.

9. The optical device of claim 1, wherein the optical device can apply a lateral field as the oscillating voltage across the optical layer.

10. The optical device of claim 1, wherein the first electrode and the second electrode are provided on the first substrate side.

11. The optical device of claim 10, wherein
each of the first electrode and the second electrode is an interdigitated electrode having a plurality of branches,
the first electrode and the second electrode are disposed so that the plurality of branches of the respective electrodes mesh with one another via a predetermined interspace, and
the relationships of w₁<g and w₂<g are satisfied, where w₁ is a width of each of the plurality of branches of the first electrode, w₂ is a width of each of the plurality of branches of the second electrode, and g is the predetermined interspace.

12. The optical device of claim 10, wherein
the first electrode, an insulator layer, and the second electrode are arranged in this order from the optical layer side,
the first electrode has a plurality of branches or a plurality of slits, and
the relationship of w_{B}<g_{B} or w_{S}>g_{S} is satisfied, where w_{B} is a width of each of the plurality of branches, g_{B} is a distance between adjoining two of the plurality of branches, w_{S} is a width of each of the plurality of slits, and g_{S} is a distance between adjoining two of the plurality of slits.

13. The optical device of claim 1, wherein the optical device can apply a longitudinal field as the oscillating voltage across the optical layer.

14. The optical device of claim 1, further comprising a third electrode which is provided on the second substrate side and which opposes the first electrode and the second electrode.

15. The optical device of claim 1, wherein the optical device is driven at a frequency of not less than 1 Hz and not more than 300 Hz.

16. The optical device of claim 1, wherein the optical device is driven at a frequency of not less than 1 Hz and not more than 100 Hz.

17. The optical device of claim 1, wherein the medium is a liquid crystal material.

18. The optical device of claim 1 wherein, when no voltage is applied across the optical layer, the anisotropically-shaped particles orient generally perpendicular to a substrate plane.

19. A display device comprising the optical device as set forth in claim 1.
